(19) United States
(12) Patent Application Publication
(10) Pub. No.: US 2014/0115120 A1
(43) Pub. Date: Apr. 24, 2014

(54) Content Delivery Network CDN Routing Method, Device, and System

(71) Applicant: Huawei Technologies Co., Ltd., Shenzhen (CN)

(72) Inventors: Jincheng Li, Xi'an (CN); Jing Wang, Shenzhen (CN)

(73) Assignee: Huawei Technologies Co., Ltd., Shenzhen (CN)

(21) Appl. No.: 14/143,310

(22) Filed: Dec. 30, 2013

Related U.S. Application Data
(63) Continuation of application No. PCT/CN2011/083985, filed on Dec. 14, 2011.

(51) Int. Cl. H04L 29/08

(52) U.S. Cl. CPC H04L 67/06
USPC 709/219

(57) ABSTRACT

A content delivery network (CDN) routing method, device and system. The file path identifier is bound to the server. When a file request is received, the file path identifier carried in the file request is extracted, and the server that provides a service is determined according to the binding relationship between the file path identifier and the server, and therefore, the requests that ask for the same file are routed to the same server that provides a service, which prevents the same file request from being routed to different servers and prevents repeated caching of the file content. In addition, because the requests that ask for the same file are routed to the same server, the user request hit ratio is improved, and the system response speed is increased, which improves the user experience.

### CROSS-REFERENCE TO RELATED APPLICATIONS

This application is a continuation of International Application No. PCT/CN2011/083985, filed on Dec. 14, 2011, which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of multimedia information technologies, and in particular, to a content delivery network (CDN) routing method, device, and system.

### BACKGROUND

A CDN delivers content to the network edge so that the service is available nearby in a distributed manner. In the CDN, an edge server cluster is deployed at each node of the network. The edge server cluster is formed by multiple servers, and a CDN routing device directs a user request to a proper server in real time according to the network traffic and the load status of the server. For a user, the CDN system provides an acceleration service, shortens the time of response to a service request, improves stability of data transmission, and improves network service quality.

Currently, when receiving a user request, the CDN routing device generally selects a lightest-loaded server in an edge server cluster closest to the user according to the load status of the server, and uses the server to serve the user. If the server has not cached the content requested by the user, the server requests to download the content from an upper-level content source server. However, in the foregoing user request routing policy, the same content is repeatedly cached in the same edge server cluster, leading to a waste of a storage resource, low hit ratio of the user request, low response speed of the system, and poor user experience.

### SUMMARY

Embodiments of the present invention provide a CDN routing method, device, and system to solve a problem where the user request hit ratio is low because the same content is repeatedly cached in the same edge server cluster when the user request is directed according to an existing routing policy.

An embodiment of the present invention provides a CDN routing method, including: receiving a file request sent by a terminal device; extracting a file path identifier carried in the file request, where the file path identifier is used to indicate a network address of a file requested by the terminal device; according to the file path identifier, obtaining an Internet Protocol (IP) address of a server bound to the file path identifier; and returning the IP address of the server to the terminal device.

An embodiment of the present invention further provides a CDN routing device, including: a receiving module configured to receive a file request sent by a terminal device; an extracting module configured to extract a file path identifier carried in the file request, where the file path identifier is used to indicate a network address of a file requested by the terminal device; an obtaining module configured to: according to the file path identifier, obtain an IP address of a server bound to the file path identifier; and a sending module configured to return the IP address of the server to the terminal device.

An embodiment of the present invention further provides a CDN routing system, including a CDN routing device and a server. The CDN routing device is configured to: receive a file request sent by a terminal device; extract a file path identifier carried in the file request, where the file path identifier is used to indicate a network address of a file requested by the terminal device; according to the file path identifier, obtain an IP address of a server bound to the file path identifier; and return the IP address of the server to the terminal device; and the server is configured to provide a file service for the terminal device.

In the embodiments of the present invention, the file path identifier is bound to the server. When a file request is received, the file path identifier carried in the file request is extracted, and the server that provides a service is determined according to the binding relationship between the file path identifier and the server, and therefore, the requests that ask for the same file are routed to the same server that provides a service, which prevents the same file request from being routed to different servers and prevents repeated caching of the file content. In addition, because the requests that ask for the same file are routed to the same server, the user request hit ratio is improved, and the system response speed is increased, which improves the user experience.

### BRIEF DESCRIPTION OF DRAWINGS

FIG. 1 is a schematic flowchart of a CDN routing method according to an embodiment of the present invention;

FIG. 2A-2B are schematic flowcharts of a CDN routing methods according to another embodiment of the present invention;

FIG. 3 is a schematic structural diagram of a CDN routing device according to an embodiment of the present invention;

FIG. 4 is a schematic structural diagram of a CDN routing device according to another embodiment of the present invention;

FIG. 5 is a schematic structural diagram of a CDN routing device according to another embodiment of the present invention; and

FIG. 6 is a schematic structural diagram of a CDN routing system according to an embodiment of the present invention.

### DESCRIPTION OF EMBODIMENTS

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

First, an overall technical solution of method embodiments of the present invention is described.

### Method Embodiment 1

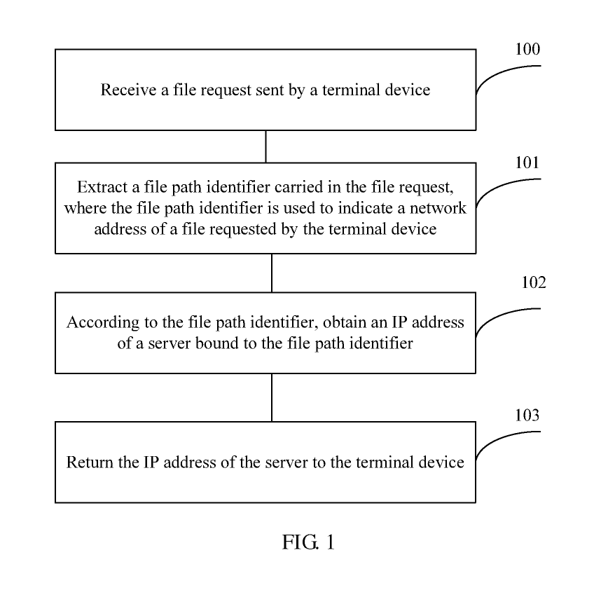

FIG. 1 is a schematic flowchart of a CDN routing method according to an embodiment of the present invention. As shown in FIG. 1, the method in the embodiment of the present invention includes the following steps:

Step 100: Receive a file request sent by a terminal device.

Step 101: Extract a file path identifier carried in the file request, where the file path identifier is used to indicate a network address of a file requested by the terminal device.

In the embodiment of the present invention, the extracting the file path identifier carried in the file request may include: identifying a protocol type used by the file request, and extracting the file path identifier according to the protocol type used by the file request.

The protocol type used by the file request may be identified in one of the following manners: manner 1 identifies the protocol type used by the file request by presetting a prefix of the file request and the protocol type used by the file request; and manner 2 identifies the protocol type used by the file request by using a regular expression.

In addition, after the protocol type used by the file request is identified, a regular expression may be used to extract the file path identifier carried in the file request.

Specifically, a regular expression for extracting the file path identifier may be determined according to the protocol type used by the file request, and the file path identifier is extracted according to the regular expression.

Step 102: According to the file path identifier, obtain an IP address of a server bound to the file path identifier.

In the embodiment of the present invention, the IP address of the server bound to the file path identifier is obtained according to the file path identifier, and then a path table can be searched according to the file path identifier, and the IP address of the server is obtained according to the path table, where the path table records a binding relationship between the file path identifier and the IP address of the server.

It should be noted that the searching the path table according to the file path identifier may include: performing a Hash algorithm operation for the file path identifier to obtain a file path identifier value, and searching the path table according to the file path identifier value.

Step 103: Return the IP address of the server to the terminal device.

In the embodiment of the present invention, the file path identifier is bound to the server. When a file request is received, the file path identifier carried in the file request is extracted, and the server that provides a service is determined according to the binding relationship between the file path identifier and the server, and therefore, the requests that ask for the same file are routed to the same server that provides a service, which prevents the same file request from being routed to different servers and prevents repeated caching of the file content. In addition, because the requests that ask for the same file are routed to the same server, the user request hit ratio is improved, and the system response speed is increased, which improves the user experience.

### Method Embodiment 2

The following describes the technical solution of the present invention in detail, assuming that a CDN employs Hyper Text Transfer Protocol (HTTP) redirection routing mode.

It should be noted that, in the embodiment of the present invention, a terminal device may interact with a CDN routing device using different interaction protocols. In the embodiment of the present invention, the terminal device interacts with the CDN routing device using an adaptive streaming protocol (e.g. HTTP Live Streaming (HLS)).

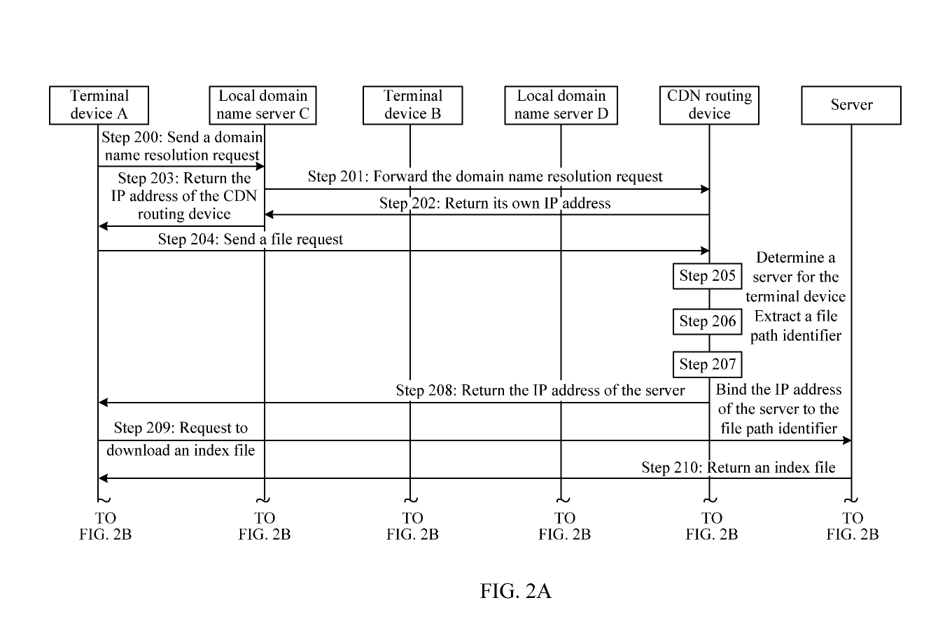

FIGS. 2A-2B are schematic flowchart of a CDN routing method according to another embodiment of the present invention. As shown in FIG. 2A-2B, the method in the embodiment of the present invention includes the following steps:

Step 200: A terminal device A sends a domain name resolution request to a local domain name server C.

The terminal device A obtains a uniform resource locator (URL) from a website. For example, http://www.sina.com/video/sports/NBA.ism/manifest

The terminal device A sends the domain name www.sina.com carried in the URL to the local domain name server C, requesting to resolve the domain name.

Step 201: The local domain name server C forwards the domain name resolution request to the CDN routing device.

Step 202: The CDN routing device returns its own IP address to the local domain name server C.

Step 203: The local domain name server C returns the IP address of the CDN routing device to the terminal device A.

Step 204: The terminal device A sends a file request to the CDN routing device, requesting to download an index file “manifest”.

For example, the terminal device A may send a file request to the CDN routing device, where the file request may be in the following format: http://www.sina.com/video/sports/NBA.ism/manifest

Step 205: The CDN routing device determines a server for the terminal device A according to a preset routing policy.

Step 206: The CDN routing device extracts a file path identifier from the file request sent by the terminal device A.

In the embodiment of the present invention, before extracting the file path identifier from the file request sent by the terminal device A, the CDN routing device needs to identify the protocol type used by the file request.

The CDN routing device may, by presetting a prefix of the file request and the protocol type corresponding to the prefix, identify the protocol type used by the file request.

For example, for a file request sent by using the adaptive streaming protocol (Apple HTTP Live Streaming, HLS) developed by Apple Inc., the file request format of the requested manifest file is as follows: http://www.sina.com/video/sports/NBA20111010/NBA.m3u8

The file request format of a requested audio and video fragment file is as follows: http://www.sina.com/video/sports/NBA20111010/NBA_bitrate_timerange.ts where bitrate and time range are variables, and, depending on the bit rate of the requested file, the bitrate comes in many types, such as 384000, 576000, and so on; and, depending on the location of the fragment of the requested file in the entire video file, the time range also varies.

For the file request sent by using the adaptive streaming protocol (e.g. Apple HLS) developed by Apple Inc., it is evident that: “http://www.sina.com/video/sports/NBA20111010” is invariable, and therefore, “http://www.sina.com/video/sports/NBA20111010” may be preset as a prefix, and the protocol type specified for the prefix is HLS, and therefore, when the CDN routing device receives a file request that includes “http://www.sina.com/video/sports/NBA20111010”, the protocol type used by the file request is identifiable.

After identifying the protocol type used by the file request, the CDN routing device may use a regular expression to extract the file path identifier in the file request.

It should be noted that, because the file path identifier specified by each protocol type is expressed in a fixed manner, a regular expression for extracting the file path identifier may be preset.

For example, when the CDN routing device identifies that an HLS protocol is being used by the file request, a regular expression exclusively used for extracting the file path identifier of HLS protocol-based file requests is invoked to extract the file path identifier.

The CDN routing device may also use the regular expression to identify the protocol type of the file request.

For example, for a file request sent by using the adaptive streaming protocol (e.g. Microsoft Smooth Streaming(MSS)) developed by Microsoft, the file request format of a requested index file is as follows: http://www.sina.com/video/sports/NBA.ism/manifest

For a file request sent by using the adaptive streaming protocol (e.g. Apple HLS) developed by Apple Inc., the file request format of the requested manifest file is as follows: http://www.sina.com/video/sports/NBA20111010/NBA.m3u8

The CDN routing device may preset the following regular expressions shown in Table 1:

TABLE 1

| Protocol type | Source regular expression |
|---|---|
| MSS protocol | \hat{ }(.*/)?(.*)\.ism([1])?/((QualityLevels\(([0-9]+)\)/ |
| | ((Fragments)\|(FragmentInfo))\((([vVaA]).*)=([0-9]+)\) |
| | (.*))\|([Mm]anifest(.*)))$ |
| HLS protocol | \hat{ }(.*/)?(.*)\.(m3u8\|ts)(.*)$ |

When the CDN routing device receives a file request, the source regular expression is used to extract characters of the URL. If the source regular expression corresponding to the MSS protocol can extract the URL completely, it is determined that the protocol used by the received file request is the MSS protocol; and, if the source regular expression corresponding to the HLS protocol can extract the URL completely, it is determined that the protocol used by the received file request is the HLS protocol.

After identifying the protocol type used by the file request, the CDN routing device may use a regular expression to extract the file path identifier in the file request.

It should be noted that, because the file path identifier specified by each protocol type is expressed in a fixed manner, a regular expression for extracting the file path identifier may be preset.

For example, when the CDN routing device identifies that an HLS protocol is being used by the file request, a regular expression exclusively used for extracting the file path identifier of HLS protocol-based file requests is invoked to extract the file path identifier.

It should be noted that the above examples are illustrative in nature and shall not be construed as a limitation.

Step 207: The CDN routing device binds the IP address of the server to the file path identifier.

The CDN routing device may bind the IP address of the server to the file path identifier to form a path table, for example, a path table shown in Table 2:

TABLE 2

| | |
|---|---|
| http://www.sina.com/video/sports/NBA20111010/ | 219.133.0.1 |
| | (streaming server 1) |
| http://www.sina.com/video/sports/NBA.ism/ | 219.133.0.2 |
| | (streaming server 2) |
| . . . | 219.133.0.3 |
| | (streaming server 3) |

Step 208: The CDN routing device returns the IP address of the server to the terminal device A.

Step 209: The terminal device A requests to download an index file from the server.

Step 210: The server returns the index file to the terminal device A.

Step 211: The terminal device A obtains a file fragment according to an address of the file fragment recorded in the index file.

It should be noted that in the embodiment of the present invention, the file is downloaded by the server from the content source server or an upper-level server on a condition that the file requested by the terminal device is not cached. After obtaining the file, the server sends the file to the terminal device, and caches the downloaded content.

Step 212: A terminal device B sends a domain name resolution request to a local domain name server D.

In the embodiment of the present invention, the file requested by the terminal device B is the same as the file requested by the terminal device A, and the terminal device B also obtains the same URL from the website, for example, http://www.sina.com/video/sports/NBA.ism/manifest

The terminal device B sends the domain name www.sina.com carried in the URL to the local domain name server D, requesting to resolve the domain name.

Step 213: The local domain name server D sends the domain name resolution request to the CDN routing device.

Step 214: The CDN routing device returns its own IP address to the local domain name server D.

Step 215: The local domain name server D returns the IP address of the CDN routing device to the terminal device B.

Step 216: The terminal device B sends a file request to the CDN routing device, requesting to download an index file “manifest”.

For example, the terminal device B may send a file request to the CDN routing device, where the file request is in the following format: http://www.sina.com/video/sports/NBA.ism/manifest

Step 217: The CDN routing device extracts a file path identifier from the file request.

The manner used by the CDN routing device to extract the file path identifier from the file request has been described in step 206, and is not repeated herein.

Step 218: The CDN routing device searches a path table according to the file path identifier to obtain the IP address of the server.

In the embodiment of the present invention, the CDN routing device searches the path table, and can find the IP address of the corresponding server according to the binding relationship between the IP address of the server and the file path identifier.

Step 219: The CDN routing device returns the IP address of the server to the terminal device B.

Step 220: The terminal device B requests to download an index file from the server.

Step 221: The server returns the index file to the terminal device B.

Step 222: The terminal device B obtains a file fragment according to an address of the file fragment recorded in the index file.

In addition, it should be noted that, in the embodiment of the present invention, the CDN routing device may bind the file path identifier to the IP address of the server manually beforehand, so that the requests that ask for the same file content are routed to the same server.

For example, a Hash operation is performed for the file path identifier that needs to be bound to the IP address of the server beforehand, and a Hash result modulo 16 is a Hash value range from 1 to 15. The Hash values 1 to 5 are bound to the IP address of server 1, the Hash values 6 to 10 are bound to the IP address of server 2, and the Hash values 11 to 15 are bound to the IP address of server 3 to form the following path table, as shown in Table 3:

TABLE 3

| File path identifier value | IP address of the server |
|---|---|
| 1, 2, 3, 4, 5 | 219.133.0.1 (server 1) |
| 6, 7, 8, 9, 10 | 219.133.0.2 (server 2) |
| 11, 12, 13, 14, 15 | 219.133.0.3 (server 3) |
| . . . | . . . |

Specifically, upon receiving the file request sent by the terminal device, the CDN routing device extracts the file path identifier, and uses a Hash algorithm to operate the file path identifier to obtain the file path identifier value. According to the file path identifier value, path table 2 may be searched to obtain the IP address of the server.

For example, the CDN receives the file request and extracts the file path identifier in the file request as: http://www.sina.com/video/sports/NBA.ism/.

The file path identifier is operated with a Hash algorithm, as shown in Table 4:

TABLE 4

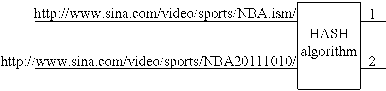

After the operation is performed with the Hash algorithm, the obtained file path identifier value is 1, Table 2 is searched according to the path identifier value 1, it is determined that the IP address of the server providing a service for the file path identifier value 1 is 219.133.0.1, and the CDN routing device returns the IP address to the terminal device. In this way, all requests that ask for the same file are routed to the server of the IP address 219.133.0.1.

When the IP address of the server is found directly according to the file path identifier, the overhead of the CDN routing device is large. However, if the file path identifier is operated with the HASH algorithm to obtain a file path identifier value and the IP address of the server is determined according to the mapping relationship between the file path identifier value and the server, the overhead of the CDN routing device can be saved.

In the embodiment of the present invention, the CDN routing device binds the file path identifier to the IP address of the server, and therefore, when the CDN routing device receives a request from the terminal device that asks for the same file, the CDN routing device lets the same server serve the terminal device, thereby avoiding the following problems: the requests that ask for the same file are routed to other servers, the file request hit ratio of the terminal device decreases, the same content is cached in other servers, and a waste of a storage resource occurs.

It should also be noted that, in a specific implementation process, after obtaining the index file, the terminal device sends a request to the CDN routing device for routing every time when the terminal device requests a file fragment from the server, which increases network consumption. To prevent every file segment request from being sent to the CDN routing device for routing, the terminal device may use an IP address of the server as an address from which the terminal device requests the file fragment subsequently, where the IP address of the server is returned by the CDN routing device.

The following describes an overall technical solution of device embodiments of the present invention.

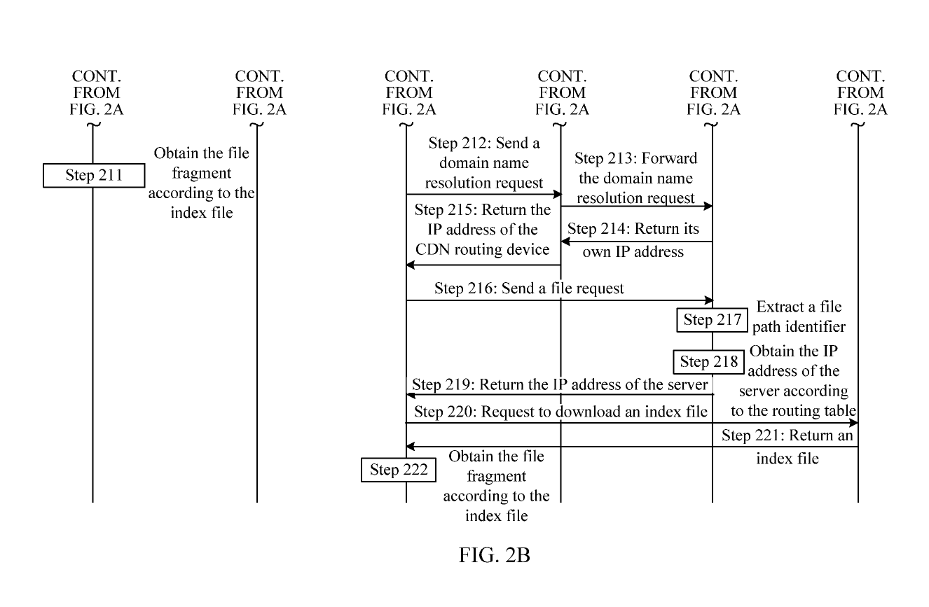

FIG. 3 is a schematic structural diagram of a CDN routing device according to an embodiment of the present invention. As shown in FIG. 3, the CDN routing device 30 may include a receiving module 300, an extracting module 301, an obtaining module 302, and a sending module 303.

The receiving module 300 is configured to receive a file request sent by a terminal device; the extracting module 301 is configured to extract a file path identifier carried in the file request, where the file path identifier is used to indicate a network address of a file requested by the terminal device; the obtaining module 302 is configured to: according to the file path identifier, obtain an IP address of a server bound to the file path identifier; and the sending module 303 is configured to return the IP address of the server to the terminal device.

In the embodiment of the present invention, the file path identifier is bound to the IP address of the server, and therefore, when a request is received from the terminal device that asks for the same file, the same server serves the terminal device, thereby avoiding the following problems: the requests that ask for the same file are routed to other servers, the file request hit ratio of the terminal device decreases, the same content is cached in other servers, and a waste of a storage resource occurs.

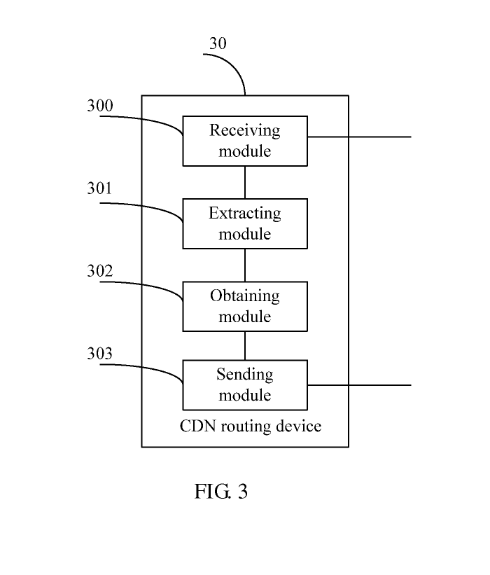

FIG. 4 is a schematic structural diagram of a CDN routing device according to another embodiment of the present invention. As shown in FIG. 4, the obtaining module 302 may include a searching unit 3021 or an obtaining unit 3022.

The searching unit 3021 is configured to search a path table according to the file path identifier, where the path table is used to record a binding relationship between the file path identifier and the IP address of the server; and the obtaining unit 3022 is configured to obtain the IP address of the server according to the path table.

The searching unit 3021 may be specifically configured to perform a Hash algorithm operation for the file path identifier to obtain a file path identifier value, and search the path table according to the file path identifier value.

In the embodiment of the present invention, when a file request is received from the terminal device, a path table that records the binding relationship between the file path identifier and the IP address of the server is searched, and therefore, the same file is routed to the same server, which prevents caching the file content repeatedly. In addition, because the requests that ask for the same file are routed to the same server, the user request hit ratio is improved, and the system response speed is increased, which improves the user experience. In addition, before the path table is searched, a Hash algorithm operation may be performed for the file path identifier to obtain a file path identifier value, and the path table is searched according to the file path identifier value, which saves the overhead of the CDN routing device.

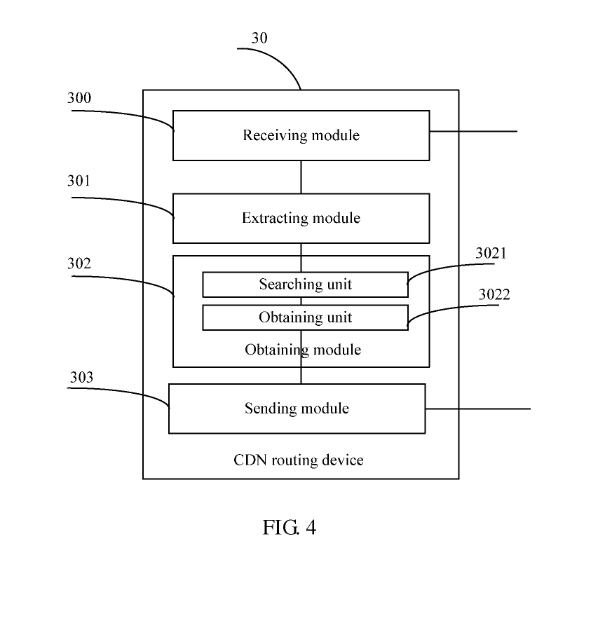

FIG. 5 is a schematic structural diagram of a CDN routing device according to another embodiment of the present invention. As shown in FIG. 5, the extracting module 301 may include an identifying unit 3011 or an extracting unit 3012.

The identifying unit 3011 is configured to identify a protocol type used by the file request; and the extracting unit 3012 is configured to extract a file path identifier according to the protocol type used by the file request, where the file path identifier is used to indicate a network address of a file requested by the terminal device. Before the file path identifier is extracted, the protocol used by the file request is identified so that the file path identifier of different file requests can be extracted accurately.

It should be noted that the extracting unit 3012 may be specifically configured to determine a regular expression for extracting the file path identifier according to the protocol type used by the file request, and extract the file path identifier according to the regular expression.

The following describes an overall technical solution of system embodiments of the present invention.

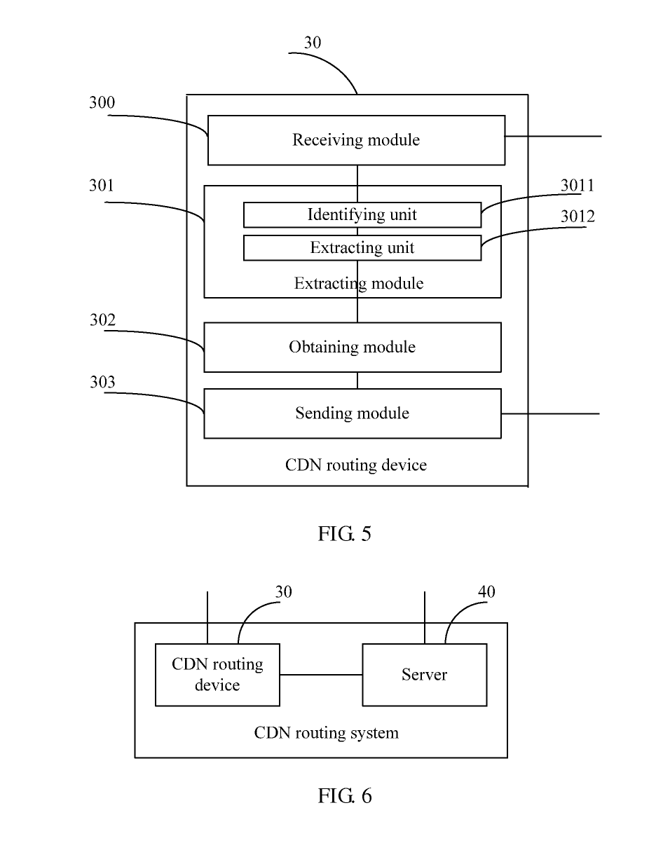

FIG. 6 is a schematic structural diagram of a CDN routing system according to an embodiment of the present invention. As shown in FIG. 6, the CDN routing system includes a CDN routing device 30 and a server 40.

The CDN routing device 30 is configured to: receive a file request sent by a terminal device; extract a file path identifier carried in the file request, where the file path identifier is used to indicate a network address of a file requested by the terminal device; according to the file path identifier, obtain an IP address of a server bound to the file path identifier; and return the IP address of the server to the terminal device.

The server 40 is configured to provide a file service for the terminal device.

It should be noted that the CDN routing device 30 may be specifically configured to: search a path table according to the file path identifier, where the path table is used to record a binding relationship between the file path identifier and the IP address of the server 40; and obtain the IP address of the server according to the path table.

It should be noted that the CDN routing device 30 may be further configured to: identify a protocol type used by the file request, and extract the file path identifier according to the protocol type used by the file request.

In the CDN routing system provided in the embodiment of the present invention, the CDN routing device 30 binds the file path identifier to the IP address of the server 40, and therefore, when the CDN routing device 30 receives a request from the terminal device that asks for the same file, the CDN routing device lets the same server 40 serve the terminal device, thereby avoiding the following problems: the requests that ask for the same file are routed to other servers, the file request hit ratio of the terminal device decreases, the same content is cached in other servers, and a waste of a storage resource occurs.

A person of ordinary skill in the art may appreciate that, in combination with the examples described in the embodiments disclosed in this specification, modules, units and steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It can be clearly understood by a person skilled in the art that, for the purpose of convenient and brief description, for a detailed working process of the foregoing system, device, module and unit, reference may be made to the corresponding process in the method embodiments, and the details will not be described herein again.

In the embodiments provided in the present application, it should be understood that the disclosed system, device, and method may be implemented in other modes. For example, the described device embodiment is merely exemplary. For example, the module division or the unit division is merely logical function division and may be other division in actual implementation. For example, a plurality of units or modules may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The modules or units described as separate parts may or may not be physically separate, and parts displayed as modules or units may or may not be physical modules or units, may be located in one position, or may be distributed on a plurality of network modules or units. A part or all of the modules or units herein may be selected according to the actual needs to achieve the objectives of the solutions of the embodiments of the present invention.

In addition, functional modules or units in the embodiments of the present invention may be integrated into one processing module or unit, or each of the modules or units may exist alone physically, or two or more modules or units are integrated into one module or unit. The integrated module or unit may be implemented in a form of hardware, or may be implemented in a form of a software functional unit.

When the integrated module or unit is implemented in the form of a software functional module or unit and sold or used as an independent product, the integrated unit may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium and includes several instructions for instructing a computer device (which may be a personal computer, a server, or a network device) to perform all or a part of the steps of the methods described in the embodiments of the present invention. The foregoing storage medium includes: any medium that can store program codes, such as a universal serial bus (USB) flash disk, a removable hard disk, a read-only memory (ROM), a random access memory (RAM), a magnetic disk, or an optical disk.

The foregoing descriptions are merely specific embodiments of the present invention, but are not intended to limit the protection scope of the present invention. Any equivalent modification or replacement figured out by a person skilled in the art within the technical scope of the present invention shall fall within the protection scope of the present invention. Therefore, the protection scope of the present invention shall be subject to the protection scope of the claims.

What is claimed is:

1. A content delivery network (CDN) routing method, comprising:
receiving a file request sent by a terminal device;
extracting a file path identifier carried in the file request, wherein the file path identifier is used to indicate a network address of a file requested by the terminal device;
obtaining an Internet Protocol (IP) address of a server bound to the file path identifier according to the file path identifier; and
returning the IP address of the server to the terminal device.

2. The method according to claim 1, wherein the obtaining, according to the file path identifier, the IP address of the server bound to the file path identifier comprises:
searching a path table according to the file path identifier, wherein the path table is used to record a binding relationship between the file path identifier and the IP address of the server; and
obtaining the IP address of the server according to the path table.

3. The method according to claim 2, wherein the searching the path table according to the file path identifier comprises:
performing a Hash algorithm operation for the file path identifier to obtain a file path identifier value; and
searching the path table according to the file path identifier value.

4. The method according to claim 1, wherein the extracting the file path identifier carried in the file request comprises:
identifying a protocol type used by the file request; and
extracting the file path identifier according to the protocol type used by the file request.

5. The method according to claim 4, wherein the identifying a protocol type used by the file request comprises one of the following manners:
a first manner that identifies the protocol type used by the file request by presetting a prefix of the file request and the protocol type used by the file request; and
a second manner that identifies the protocol type used by the file request by using a regular expression.

6. The method according to claim 4, wherein the extracting the file path identifier according to the protocol type used by the file request comprises:
determining a regular expression for extracting the file path identifier according to the protocol type used by the file request; and
extracting the file path identifier according to the regular expression.

7. The method according to claim 5, wherein the extracting the file path identifier according to the protocol type used by the file request comprises:
determining a regular expression for extracting the file path identifier according to the protocol type used by the file request; and
extracting the file path identifier according to the regular expression.

8. A content delivery network (CDN) routing device, comprising:
a receiving module configured to receive a file request sent by a terminal device;
an extracting module configured to extract a file path identifier carried in the file request, wherein the file path identifier is used to indicate a network address of a file requested by the terminal device;
an obtaining module configured to obtain an Internet Protocol (IP) address of a server bound to the file path identifier according to the file path identifier; and
a sending module configured to return the IP address of the server to the terminal device.

9. The device according to claim 8, wherein the obtaining module comprises:
a searching unit configured to search a path table according to the file path identifier, wherein the path table is used to record a binding relationship between the file path identifier and the IP address of the server; and
an obtaining unit configured to obtain the IP address of the server according to the path table.

10. The device according to claim 9, wherein the searching unit is configured to perform a Hash algorithm operation for the file path identifier to obtain a file path identifier value, and search the path table according to the file path identifier value.

11. The device according to claim 8, wherein the extracting module comprises:
an identifying unit configured to identify a protocol type used by the file request; and
an extracting unit configured to extract a file path identifier according to the protocol type used by the file request, wherein the file path identifier is used to indicate a network address of a file requested by the terminal device.

12. The device according to claim 11, wherein the extracting unit is configured to: determine a regular expression for extracting the file path identifier according to the protocol type used by the file request and extract the file path identifier according to the regular expression.

13. A content delivery network (CDN) routing system, comprising
a CDN routing device; and
a server,
wherein the CDN routing device is configured to:
receive a file request sent by a terminal device;
extract a file path identifier carried in the file request, wherein the file path identifier is used to indicate a network address of a file requested by the terminal device;
obtain an Internet Protocol (IP) address of a server bound to the file path identifier according to the file path identifier; and
return the IP address of the server to the terminal device, and
wherein the server is configured to provide a file service for the terminal device.

14. The system according to claim 13, wherein the CDN routing device is configured to obtain the IP address of the server bound to the file path identifier by:
searching a path table according to the file path identifier, wherein the path table is used to record a binding relationship between the file path identifier and the IP address of the server; and
obtaining the IP address of the server according to the path table.

15. The system according to claim 13, wherein the CDN routing device is configured to extract the file path identifier carried in the file request by: identifying a protocol type used by the file request and extracting the file path identifier according to the protocol type used by the file request.

16. The system according to claim 14, wherein the CDN routing device is configured to extract the file path identifier carried in the file request by: identifying a protocol type used by the file request and extracting the file path identifier according to the protocol type used by the file request.
